(19) United States
(12) Patent Application Publication
(10) Pub. No.: US 2004/0237688 A1
(43) Pub. Date: Dec. 2, 2004

(54) Moving part intended to come into contact with another moving or fixed element

(76) Inventor: Pierre Kunz, Echenevex (FR)

Correspondence Address: OSTROLENK FABER GERB & SOFFEN, 1180 AVENUE OF THE AMERICAS, NEW YORK, NY, 100368403

(21) Appl. No.: 10/800,366

(22) Filed: Mar. 12, 2004

(30) Foreign Application Priority Data
Mar. 12, 2003 (CH) 0385/03

(51) Int. Cl. F27D 15/02

(52) U.S. Cl. 74/440

(57) ABSTRACT

The moving part has a hub (2) turning on its axis (A) and a transmission or working zone (4) intended to come into contact with a moving or fixed element, an elastic zone (3) likely to undergo a deformation being placed in between the hub (2) and the transmission or working zone (4).

The invention consists of a moving part intended to come into contact with another moving or fixed element.

In watch-making, for example, when an additional moving part is added to an existing mechanism, the pin of a moving part often has to pass right through the mechanism plate in order to indicate something on the face, for example. As a result, the pin of the moving part may come into contact with one or more existing components of the movement. Therefore, numerous complications arise if you have to change the position of the swivel pin of the moving part going right through the mechanism plate. This problem led the holder to propose a moving part that can be made to shift in relation to its pin, in such a way as to avoid contact with a pin or any other component of the movement. The pressure exerted on the moving part will shift the pin of the said moving part. The centre of the moving part will undergo a deformation and the outer edge will be shifted laterally. Thus, the holder suggests proposing a moving part with a certain elasticity at its centre allowing it to be shifted without changing a centre distance, without altering its function and without changing its performance.

The moving part according to the invention is characterised by the fact that it includes a hub turning on its axis, and a transmission or working zone intended to come into contact with the moving or fixed element, with an elastic zone likely to undergo a deformation placed in between the hub and the transmission zone.

According to a preferred method of construction, the elastic zone can consist of deformable foam or a succession of thin plates linking the hub to the transmission or working zone.

The transmission or working zone can be in the form of a toothed wheel.

The moving part according to the invention can be subjected to a pressure exerted by a bridge or a bar applied to the transmission zone, the pressure exerted by the bridge bringing the moving part into contact with another moving part to be moved by deforming the elastic zone and shifting the rotation axis of the said moving part.

The moving part can be used as a component part of a clutch.

The transmission zone of the moving part can present a succession of teeth butting up against a section of a bridge or a fixed counterbore, the advance of a step or a tooth being achieved by the deformation of the elastic zone of the moving part. In this case, the moving part can be in the shape of a star.

The transmission zone of the moving part can be put together in such a way as to create a friction bearing or drive. The moving part invented could also be used in mechanics in general, particularly in the automobile industry, aviation, medicine, etc.

The drawings attached represent, as an example, several methods of construction of a moving part likely to be shifted in relation to its axis.

In the drawings:

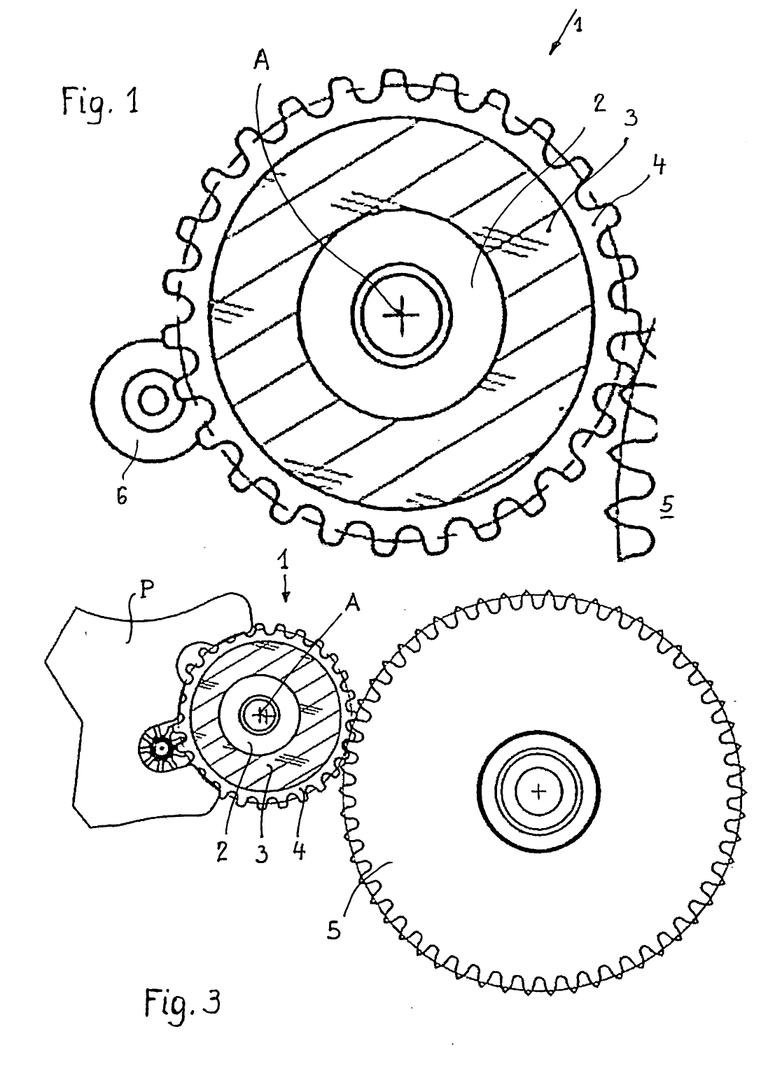

FIG. 1 represents a top view of a first method of construction of the moving part,

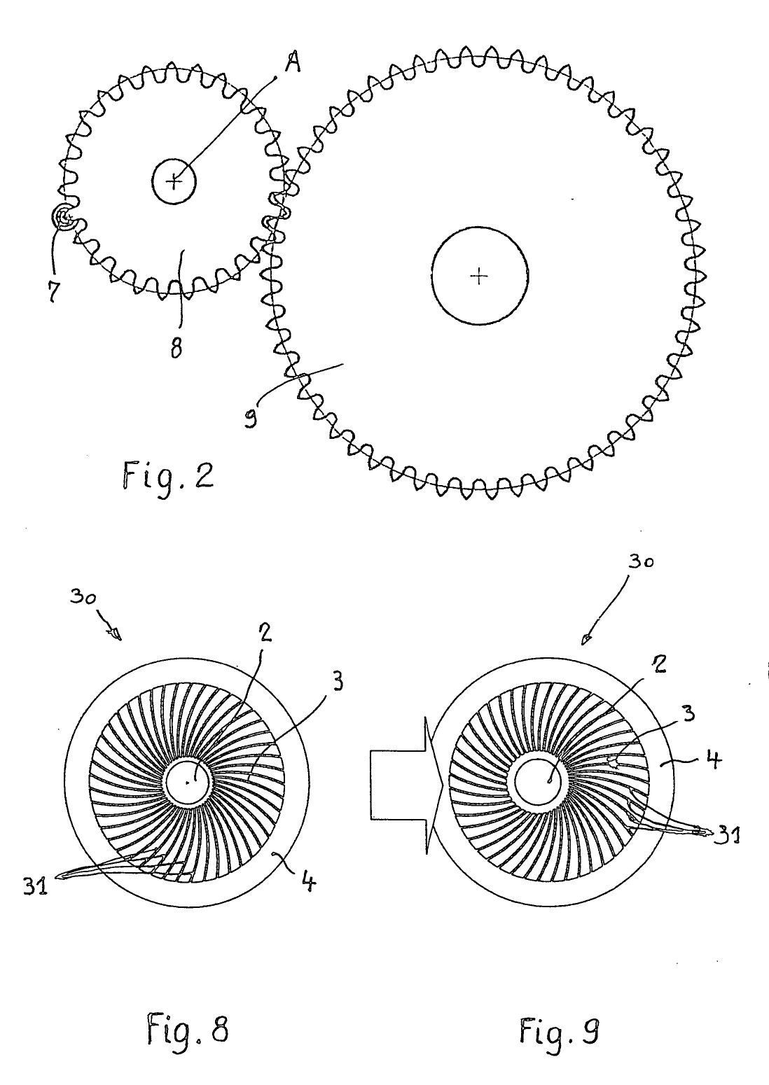

FIG. 2 shows a situation encountered in watch-making, where the periphery of a toothed wheel arrives exactly on a swivel pin,

FIG. 3 is a view of the method of construction in FIG. 1, the moving part being brought into contact with a toothed wheel by the action of a bridge exerting a pressure against the moving part by shifting its swivel pin,

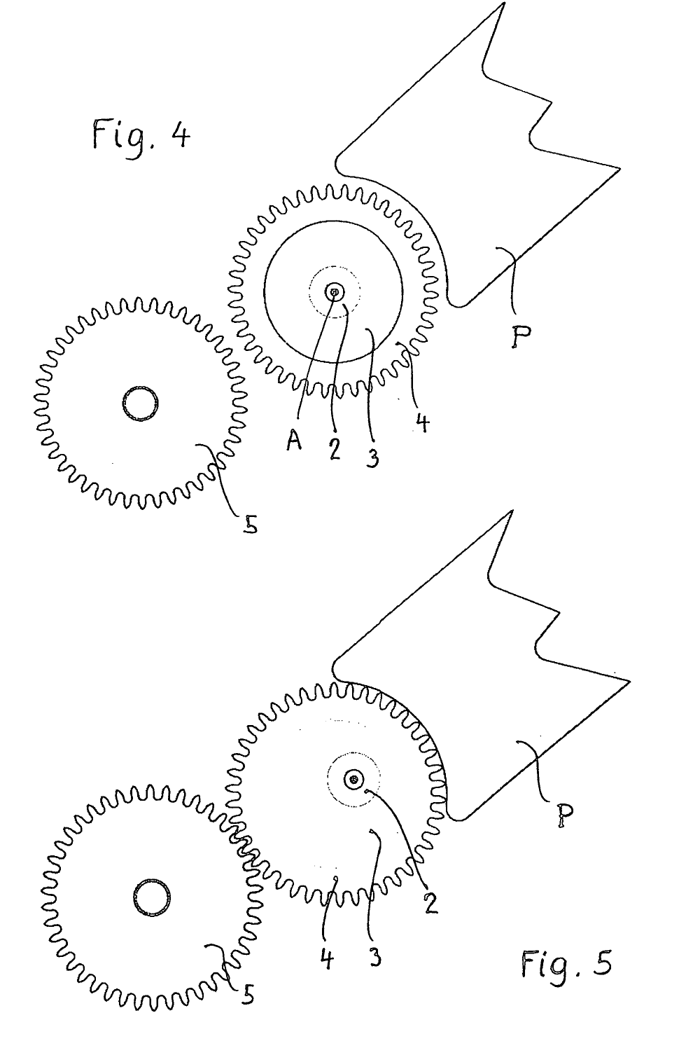

FIG. 4 shows, in rest position, a clutch between two moving parts activated by a bridge,

FIG. 5 shows the clutch of FIG. 4 in locked position by pressure exerted by the bridge,

FIG. 6 shows a method of construction in which a bridge or a counterbore serves as a stop for a star,

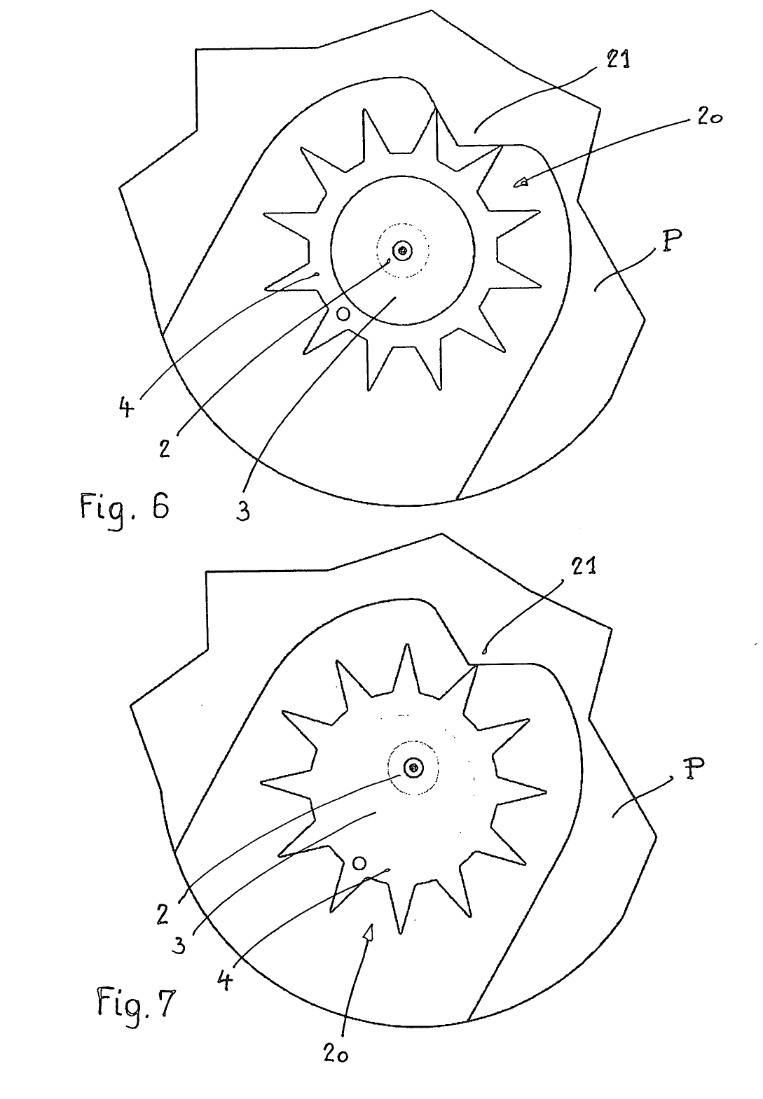

FIG. 7 shows the star shifting by a notch in relation to the process of the bridge in FIG. 6,

FIG. 8 shows a moving part with a succession of spring plates extending from its centre to its periphery, and

FIG. 9 shows the moving part in FIG. 8 subjected to a lateral shift.

The moving part described in the different methods of construction has been developed for the watch-making industry. However, its application is not limited to this particular sector, and can be extended to mechanics in general, particularly the automobile industry, aviation, micro-mechanics, machine tools, medicine, and all sectors of technology in which a moving part has to be brought into contact with a fixed or moving mechanical element, by a deformation of the structure corresponding to a shift of its centre of rotation.

The moving part represented in the different methods of construction has been developed for industry. Once in place, the moving part represented in the method of construction in FIG. 1 can be brought into contact with another moving element or any other sort of transmission by being shifted from its swivel pin A.

The moving part 1 consists of three separate parts:

a hub 2,

an elastic part 3, and

a transmission zone 4.

In FIG. 1, the moving part 1 comes into contact with another moving part 5 and is driven by a pinion 6, which exerts a lateral pressure on the transmission zone 4 and brings it into contact with the moving part 5, the rotation centre A of the moving part 1 being then slightly shifted to the right.

The elastic part can consist of flexible elements such as foams or springs. With the help of modern technologies, we can make this part flexible and yet small.

The shifted moving part can even be shifted intermittently in full movement. This does not result in any change in operation. It can also be shifted permanently.

The operation of the moving part 1 in FIG. 1 will be explained in detail with regard to FIG. 3.

FIG. 2 shows one of the problems encountered by watch-makers, in which a pin passing through the mechanism plate of a watch comes into contact with the edge of a mechanism of the movement.

When an additional module is added to an existing mechanism, it often happens that the pin of a moving part has to pass right through the mechanism plate in order to indicate something on the face, for example. As a result, the pin can come into contact with one or more existing components, for example moving part 8 engaging another moving part 9. There are therefore numerous complications if you have to change the position of the swivel pin 7. This situation has led to the solution proposed to overcome this problem. One simply has to slightly force the moving part to avoid the pin 7, without changing a single centre distance, without altering the function and without changing the performance of the moving parts.

This solution can also overcome smaller problems encountered in watch-making, such as roundness¹ defects in moving parts or bracing problems between moving parts. Minor defects due to the positions of the swivel holes of different moving parts can also be easily corrected. ¹Translator's note: “mal ronds” is assumed to mean “roundness”, although only one reference to it could be found anywhere.

In the view in FIG. 3, the moving part 1 is in contact with a bridge P or any component whatsoever coming into contact with the transmission zone or a solid part of this zone. The pressure exerted by the bridge P puts a stress on the elasticity of the central part shifting only the part containing the transmission zone. This remains in contact with the next moving part, and the theoretical positioning of the swivel pin A of hub 2 remains unchanged.

The main advantage lies in the fact that the transmission ratio or the angular pitch is maintained whilst being shifted from its swivel pin A. No need to change the module or the centre distance or even the ratio. You just have to force the moving part so that it is outside the trajectory to be avoided. It is also possible that it is our transmission zone that remains fixed, and that the hub 2 is shifted. The swivel would therefore depend on the axial performance of the transmission zone 4, which does not pose major problems.

The method of construction in FIGS. 4 and 5 shows a moving part 10 similar to the moving part 1 in FIGS. 1 to 3, with its hub 2, its elastic part 3, and its transmission zone 4. The moving part 10 is intended to engage another moving part 5 as in the previous method of construction and the unit shown in FIGS. 4 and 5 will function as a low motion clutch.

The elasticity of the moving part 10 is therefore used to create a low motion clutch, for example for a time meter in a timer. This same elasticity can be used in order to guarantee the penetration of the teeth with ratchets or other elements, while handling the pivots of the moving parts. In FIG. 4, the clutch is in rest position, the moving part 5 not being driven, and the elastic moving part 10 is able to turn freely on its pin A.

In FIG. 5, the bridge P undergoes a translation, comes into contact with the moving part 10, and presses it against the moving part 5 shifting the rotation axis A by a deformation of the zone 3. The moving part 10 is then in an engaged position.

In the module in FIGS. 6 and 7, the moving part 20 with its hub 2, the elastic part 3, and its transmission zone 4, is in the form of a star performing the function of a catch. The elastic part 3 of the star 20 performs the function usually performed by a spring plate. A section 21 of the catch is part of a bridge P or a fixed counterbore.

The star 20 thus advances by a notch, or a step, by a deformation of the elastic zone 3 as represented in FIG. 7, and the star comes back into place after the passage of a point relative to the section 21.

Still in the sector of watch-making, the moving part 1, 10 or 20 can be used as a lateral shock absorber for all watch applications.

In the method of construction in FIGS. 8 and 9, the moving part 30 includes a hub 2, an elastic zone 3 consisting of a succession of concentric plates 31 fixed to the hub 2 and the transmission zone 3. As mentioned above, the method of construction of FIGS. 8 and 9 is not only intended for watch-making, but can be adapted to other applications such as car suspensions for example. In fact, this system adapted vertically and directly to wheels can absorb shocks of all kinds and all directions.

1. Moving part intended to come into contact with a moving or fixed element, characterised by the fact that it includes a hub (2), turning on its axis, and a transmission or bearing wheel (4) intended to come into contact with the moving or fixed element, an elastic section (3) likely to undergo a deformation being placed between the hub (2) and the transmission zone (4).

2. Moving part according to claim 1 characterised by the fact that the elastic zone (3) is a deformable foam.

3. Moving part according to claim 1 characterised by the fact that the elastic zone (3) consists of a succession of plates linking the hub to the transmission or working zone (FIGS. 8 and 9).

4. Moving part according to claim 1 characterised by the fact that the transmission or working zone (4) is in the form of a toothed wheel.

5. Moving part according to claim 1 characterised by the fact that it is subjected to a pressure exerted by a bridge or a bar (P) applied to the transmission zone (4), the pressure bringing the moving part (1) into contact with another moving part (5) to be driven and deforming the elastic zone and shifting the rotation axis of the said moving part (1), (FIG. 3).

6. Moving part according to claim 5 characterised by the fact that the moving part is used as a component part of a clutch (FIGS. 4 and 5).

7. Moving part according to claim 1 characterised by the fact that the transmission zone (4) presents a succession of teeth butting up against a section of a bridge or a fixed counterbore (P), the advance of a step or a tooth being achieved by the deformation of the elastic zone of the moving part.

8. Moving part according to claim 3 characterised by the fact that the transmission zone (4) is in the shape of a star (FIGS. 6 and 7).

9. Moving part according to claim 1 characterised by the fact that the transmission or working zone (4) is arranged to create a friction bearing or drive (FIGS. 8 and 9).

10. The moving part according to claim 1 ca be used in mechanics in general, in the automobile industry, aviation and medicine in particular.
